(19) United States
(12) Patent Application Publication
(10) Pub. No.: US 2010/0212420 A1
(43) Pub. Date: Aug. 26, 2010

(54) INDUCTIVE FLUID LEVEL SENSOR

(75) Inventor: Gerrit VanVranken Beneker, Lake Orion, MI (US)

Correspondence Address: Quinn Law Group, PLLC, 39555 Orchard Hill Place, Suite 520, Novi, MI, 48375, US

(73) Assignee: Eaton Corporation, Cleveland, OH (US)

(21) Appl. No.: 12/392,414

(22) Filed: Feb. 25, 2009

(51) Int. Cl. G01F 23/30

(52) U.S. Cl. 73/313

(57) ABSTRACT

A sensor for measuring a level of a fluid includes a member and a bobbin defining a cavity therethrough and configured for receiving the member. The sensor also includes at least one inductive coil wound to the bobbin, wherein the at least one inductive coil defines a plurality of symmetrical layers that each extend along an axial length of the bobbin. The sensor includes a float operably connected to the member and buoyant in a fluid having a level in a container. The member axially translates within the cavity in response to a change in position of the float according to the level of the fluid so that an inductance of the at least one inductive coil varies in relation to a position of the member within the cavity and thereby in relation to the level of the fluid.

### TECHNICAL FIELD

The invention relates to a sensor for measuring a level of a fluid.

### BACKGROUND OF THE INVENTION

Fluid level sensors measure an amount of fluid in a container. One type of fluid level sensor, a fuel level sensor, is typically useful for transportation applications. In particular, a fuel level sensor typically measures an amount of fuel in a fuel tank and provides a signal to a fuel gauge of a vehicle.

Existing fuel level sensors often include a float connected to a wiper arm. The float typically rests on top of fuel in the fuel tank and changes position based on the changing level of fuel. As the float changes position, one end of the wiper arm contacts a variable resistor, which may include a strip of resistive material, and creates an electrical circuit. As the wiper arm slides across the strip of resistive material, a resistance of the electrical circuit changes according to fuel level.

However, some existing fuel level sensors may be subject to oxidative degradation from fuel components often found in degraded gasoline. Oxidative degradation increases the resistance of the electrical circuit and may decrease durability of the fuel level sensor.

### SUMMARY OF THE INVENTION

A sensor for measuring a level of a fluid includes a member and a bobbin. The bobbin defines a cavity therethrough and is configured for receiving the member. The sensor also includes at least one inductive coil wound to the bobbin, wherein the at least one inductive coil defines a plurality of symmetrical layers that each extend along an axial length of the bobbin. Further, the sensor includes a float operably connected to the member and buoyant in a fluid having a level in a container. The member axially translates within the cavity in response to a change in position of the float according to the level of the fluid so that an inductance of the at least one inductive coil varies in relation to a position of the member within the cavity and thereby in relation to the level of the fluid.

In another embodiment, each individual symmetrical layer of the plurality of symmetrical layers includes a substantially equal number of turns.

A method of measuring a level of a fluid includes providing an electrical current to at least one inductive coil to produce an inductance, wherein the at least one inductive coil is wound to a bobbin defining a cavity therethrough. The at least one inductive coil defines a plurality of symmetrical layers that each extend along an axial length of the bobbin. Further, a float is operably connected to a member positioned to axially translate within the cavity according to the level of the fluid. The method also includes conveying an output signal corresponding to an inductance created in the at least one inductive coil by the member when the member axially translates in the at least one inductive coil in response to a change in the level of the fluid thereby measuring the level of the fluid.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side view of a container having a sensor for measuring a level of a fluid in the container, wherein the sensor includes at least one inductive coil wound to a bobbin;

FIG. 2 is a schematic perspective view of the inductive coil wound to the bobbin of FIG. 1;

FIG. 3 is an enlarged schematic perspective view of the inductive coil wound to the bobbin of FIGS. 1 and 2 and defining a plurality of symmetrical layers;

FIG. 4 is a schematic side view of the sensor of FIG. 1 measuring a comparatively lower level of the fluid in the container;

FIG. 5 is a schematic side view of a sensor for measuring a level of a fluid in a container, wherein the sensor includes at least one inductive coil defining a plurality of symmetrical layers including a substantially equal number of turns; and

FIG. 6 is an enlarged schematic perspective view of the inductive coil of FIG. 5.

### DETAILED DESCRIPTION OF THE EMBODIMENTS

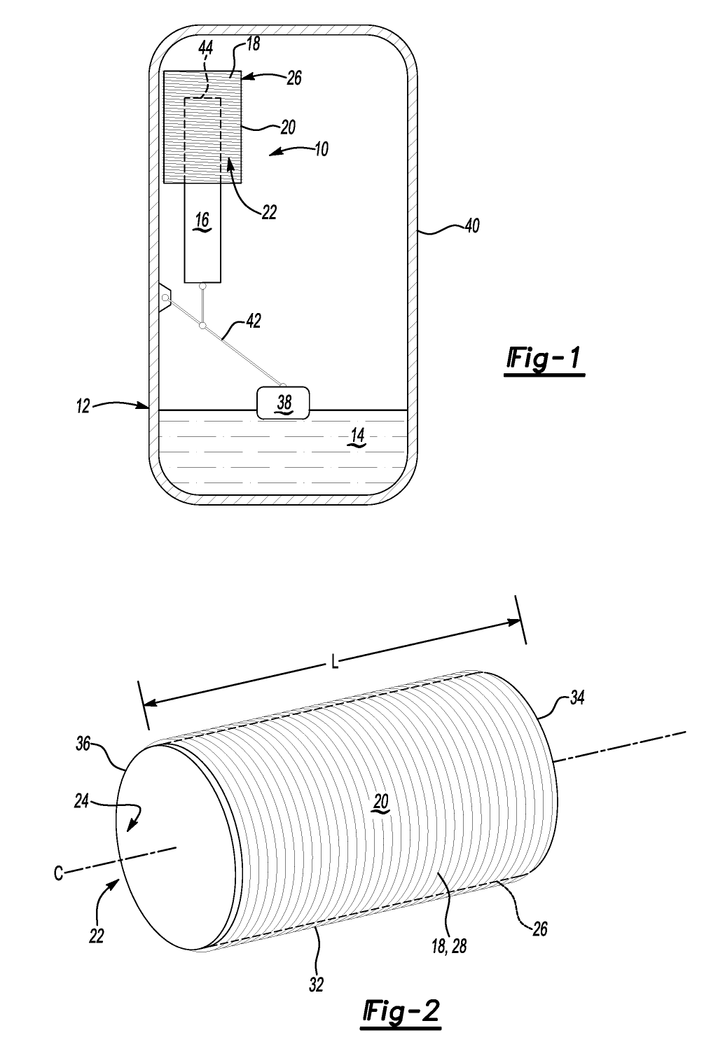

Referring to the drawings, wherein like reference numerals refer to like components, a sensor is shown generally at 10 in FIG. 1. The sensor 10 is generally useful for measuring a level 12 of a fluid 14. For example, the sensor 10 may be useful for automotive applications. In particular, the sensor 10 may be a fuel sensor for a vehicle. However, it is to be appreciated that the sensor 10 may also be useful for non-automotive applications, such as, but not limited to, aviation applications or applications requiring remote measurement of storage tanks.

Referring to FIG. 1, the sensor 10 includes a member 16. As set forth in more detail below, the member 16 generally varies an inductance of at least one inductive coil 18 of the sensor 10. As such, the member 16 may be magnetic. In particular, the member 16 may be ferromagnetic, ferrimagnetic, or a combination thereof. For example, the member 16 may be formed from a ferromagnetic material, such as iron, a ferrimagnetic material, such as magnetite, or combinations thereof. The member 16 may be a metal, such as, but not limited to, steel. The member 16 may also be formed in any suitable shape. For example, the member 16 may be an elongated cylinder or a bar. Further, the member 16 may be solid or hollow.

Referring to FIG. 1, the sensor 10 also includes a bobbin 20 defining a cavity 22 therethrough. The bobbin 20 may support the inductive coil 18 of the sensor 10, as set forth in more detail below. The bobbin 20 may be nonmagnetic. That is, the bobbin 20 may be formed from any suitable nonmagnetic material known in the art. For example, the bobbin 20 may be formed from molded plastic, such as a glass-filled thermoplastic. The bobbin 20 may also include one or more flanges (not shown) for supporting the inductive coil 18.

Additionally, since the bobbin 20 defines the cavity 22 therethrough, the bobbin 20 is hollow. That is, referring to FIG. 2, the bobbin 20 may have an inner surface 24 and an outer surface 26. As used herein, the terminology “inner” refers to elements disposed relatively closer to a central longitudinal axis C of the bobbin 20. In contrast, the terminology “outer” refers to elements disposed relatively farther from the central longitudinal axis C. The inner surface 24 of the bobbin 20 may define the cavity 22, whereas the outer surface 26 of the bobbin 20 may support the inductive coil 18.

The bobbin 20 is configured for receiving the member 16. That is, the bobbin 20 and the member 16 may have a similar shape. In one example, the bobbin 20 may be an elongated cylinder having a comparatively larger diameter than the member 16. That is, the bobbin 20 may be a hollow elongated cylinder configured for receiving a solid cylindrical member 16. Further, the member 16 may have a longer axial length than the bobbin 20 so that the bobbin 20 may partially receive the member 16. In general, a size of the cavity 22 may be determined in accordance with the dimensions of the member 16 so that, in use, the member 16 may be substantially entirely received into the cavity 22 as the member 16 axially translates along the central longitudinal axis C. As used herein, the terminology “substantially” is used to represent the inherent degree of uncertainty that may be attributed to any quantitative comparison, value, measurement, or other representation. As such, it refers to an arrangement of elements or features that, while in theory would be expected to exhibit exact correspondence or behavior, may in practice embody something slightly less than exact. The term also represents the degree by which a quantitative representation may vary from a stated reference without resulting in a change in the basic function of the subject matter at issue. Therefore, it is contemplated that the bobbin 20 may receive slightly less than an entire axial length of the member 16.

Referring to FIGS. 1 and 2, the sensor 10 includes the at least one inductive coil 18. As used herein, the terminology “inductive” refers to a coil capable of producing an inductance, i.e., a ratio of magnetic flux to current or a resistance to a change in current. In use, and as set forth in more detail below, an electrical current may be applied to the inductive coil 18 from a power source, such as, for example, a battery of a vehicle, to induce a magnetic flux. The inductive coil 18 may be formed from any electrically-conductive material capable of producing an inductance known in the art. For example, the inductive coil 18 may be formed from a wire 28. In particular, the inductive coil 18 may be a copper wire.

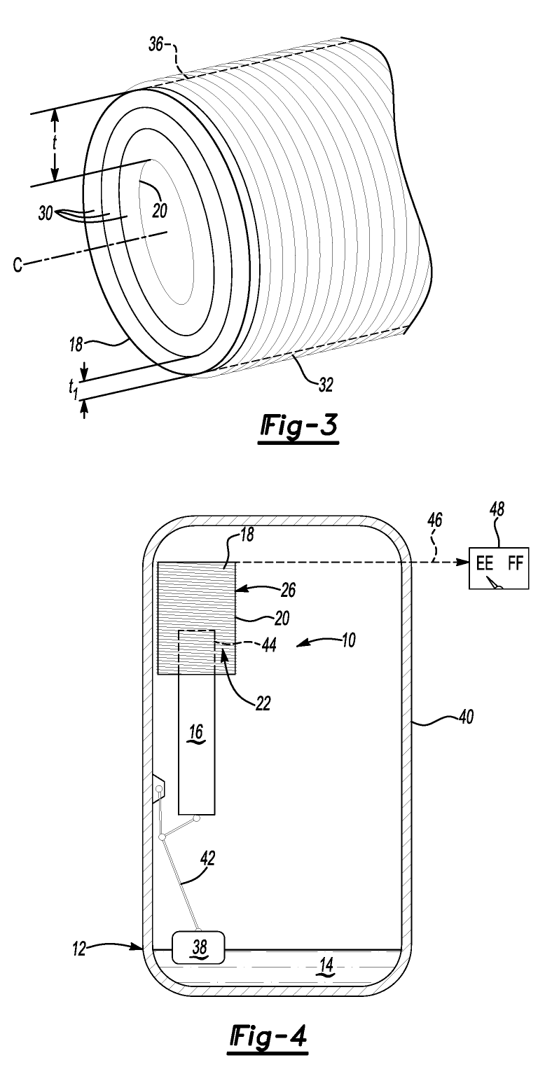

Referring to FIGS. 2 and 3, the inductive coil 18 is wound to the bobbin 20 and defines a plurality of symmetrical layers 30 that each extend along an axial length, L, of the bobbin 20. In one example, the plurality of symmetrical layers 30 may each extend along substantially an entire axial length, L, of the bobbin 20. That is, the inductive coil 18 may be a single coil wound with turns 32 along the axial length, L, of the bobbin 20 to form the symmetrical layers 30. As used herein, the terminology “turn” refers to a single complete revolution about the bobbin 20 by the wire 28. The terminology “layer” refers to multiple adjacent turns 32 of the wire 28 about the bobbin 20 extending along the axial length, L, of the bobbin 20. Further, the terminology “symmetrical” refers to correspondence of a shape and relative position of an element about a reference point.

For example, to form each individual symmetrical layer 30, the wire 28 may be wrapped continuously around the bobbin 20 at a desired pitch beginning at a proximal end 34 of the bobbin and extending to a distal end 36 of the bobbin 20 along the axial length, L, of the bobbin 20. As used herein, the terminology “pitch” refers to a number of turns 32 per axial length, L, of the bobbin 20. An adjacent individual symmetrical layer 30 of the inductive coil 18 may then be formed by continuing to wrap the wire 28 continuously around the bobbin 20 at the desired pitch 34 from the distal end 36 of the bobbin 20 to the proximal end 34 of the bobbin 20 along the axial length, L, of the bobbin 20. The winding and wrapping may be continued to form the symmetrical layers 30 of the inductive coil 18. Therefore, each individual symmetrical layer 30 may be substantially symmetrical along the axial length, L, of the bobbin 20. Likewise, each individual symmetrical layer 30 may be substantially symmetrical along substantially the entire axial length, L, of the bobbin 20.

Referring to FIGS. 2 and 3, each individual symmetrical layer 30 of the plurality of symmetrical layers 30 may include a substantially equal number of turns 32. That is, the number of turns 32, i.e., single complete revolutions about the bobbin 20, which form each individual symmetrical layer 30 is substantially equal for each individual symmetrical layer 30 wound to the bobbin 20. Therefore, when stacked radially from the central longitudinal axis C, the symmetrical layers 30 may not be staggered, e.g. may not be asymmetrical. Rather, the symmetrical layers 30 may be wound to the bobbin 20 so that the inductive coil 18 has a substantially equal cross-sectional thickness, t, along the axial length, L, of the bobbin 20. The symmetrical layers 30 may also be wound to the bobbin 20 so that the inductive coil 18 has the substantially equal cross-sectional thickness, t, along substantially the entire axial length, L, of the bobbin 20. That is, the number of turns 32 of each individual symmetrical layer 30 may not differ from layer 30 to layer 30 along corresponding portions and the axial length, L, of the inductive coil 18. Further, the number of turns 32 of each individual symmetrical layer 30 may not differ from layer 30 to layer 30 along corresponding portions and substantially the entire axial length, L, of the inductive coil 18. Stated differently, each individual symmetrical layer 30 may have a substantially equal cross-sectional thickness, tₗ, along the axial length, L, of the bobbin 20 so that each individual symmetrical layer 30 is substantially symmetrical with every other individual symmetrical layer 30. Likewise, each individual symmetrical layer 30 may have the substantially equal cross-sectional thickness, ti, along substantially the entire axial length, L, of the bobbin 20. Therefore, the individual symmetrical layers 30 may be wound, e.g., stacked about, the bobbin 20, to form the inductive coil 18 having the substantially equal cross-sectional thickness, t, along the axial length, L, of the bobbin 20. More specifically, the individual symmetrical layers 30 may be wound, e.g., stacked about, the bobbin 20, to form the inductive coil 18 having the substantially equal cross-sectional thickness, t, along substantially the entire axial length, L, of the bobbin 20. Since the sensors 10, 110 include the symmetrical layers 30, 130 and do not require staggered layers, the sensors 30, 130 are simpler and cost-effective to manufacture as compared to existing sensors.

The sensor 10 may also include more than one inductive coil 18. For example, the sensor 10 may include two or more inductive coils 18 so that a first inductive coil is disposed within a second inductive coil. Further, the inductive coil 18 may have, for example, two or more symmetrical layers 30.

Referring to FIG. 1, the sensor 10 includes a float 38. The float 38 is operably connected to the member 16 and buoyant in the fluid 14 having the level 12 in a container 40. That is, the float 38 may be buoyant aloft the fluid 14, rest on or near a top of the fluid 14, and/or float in the fluid 14. The float 38 may be formed of any suitable buoyant material and is generally selected according to physical and/or chemical properties of the fluid 14. For example, for an application including gasoline as the fluid 14, the float 38 may be formed from a plastic. To maximize flotation in the fluid 14, the float 38 may be hollow.

The float 38 is operably connected to the member 16 to effect axial translation of the member 16 within the cavity 22 of the bobbin 20 in response to a change in position of the float 38 according to the level 12 of the fluid 14 in the container 40. That is, as the level 12 of the fluid 14 in the container 40 changes, the float 38 rises or falls in the container 40 and inserts or withdraws the member 16 into or out of the cavity 22 of the bobbin 20.

Referring to FIG. 1, the float 38 may be operably connected to the member 16 by any suitable linkage 42. By way of a non-limiting example, the float 38 may be operably connected to the member 16 by an arm, a bar, a link-and-arm connector, or combinations thereof. The suitable linkage 42 may also be bent or angled, as exemplified by an L-shaped connector. Further, the suitable linkage 42 may be attached to the float 38 and the member 16 by any suitable attachment mechanism, such as a bolt, a screw, and/or an adhesive.

Referring to FIG. 1, in use, the member 16 axially translates within the cavity 22 in response to a change in position of the float 38 according to the level 12 of the fluid 14 so that an inductance of the inductive coil 18 varies in relation to a position 44 of the member 16 within the cavity 22 and thereby in relation to the level 12 of the fluid 14. That is, as the member 16 axially translates into the cavity 22, the inductance increases. Stated differently, since the inductive coil 18 is wound to the bobbin 20, as the member 16 axially translates into the cavity 22, the inductance increases. Conversely, as the member 16 axially translates out of the cavity 22, the inductance decreases.

More specifically, since the member 16 is operably connected to the float 38 and buoyant in the fluid 14, as the level 12 of the fluid 14 increases in the container 40, the member 16 axially translates into the inductive coil 18 and increases the inductance. Similarly, as the level 12 of the fluid 14 decreases in the container 40, the member 16 axially translates out of the inductive coil 18 and decreases the inductance. Therefore, by measuring the inductance, the position 44 of the member 16 within the cavity 22 may be determined and correlated to the level 12 of the fluid 14 in the container 40.

Referring to FIG. 1, when the level 12 of the fluid 14 in the container 40 is relatively high, the float 38 rests in an upper portion of the container 40, which inserts the member 16 into the cavity 22 surrounded by the inductive coil 18. Conversely, referring to FIG. 4, when the level 12 of the fluid 14 in the container 40 is relatively low, the float 38 rests in a lower portion of the container 40, which withdraws the member 16 from the cavity 22.

In use, the member 16 may not contact the inductive coil 18. That is, contact between the member 16 and the inductive coil 18 may disrupt the inductance of the inductive coil 18. Also, the member 16 may not axially translate entirely beyond the inductive coil 18. Stated differently, in use, the member 16 is generally not completely withdrawn from the cavity 22 of the bobbin 20.

Referring to FIG. 4, the sensor 10 may produce an output signal 46 corresponding to the inductance. In particular, the inductive coil 18 may provide an output signal 46 corresponding to the inductance in response to an alternating electrical current. Alternatively, the inductive coil 18 may provide an output signal 46 corresponding to the inductance in response to a pulsed direct electrical current. The output signal 46 may be electronic, digital, mechanical, and combinations thereof. For example, when the sensor 10 is a fuel level sensor for a vehicle, the output signal 46 may actuate an indicator 48 to provide a user with an indication of the level 12 of the fluid 14 in the container 40. Although shown schematically in FIG. 4, in use, the output signal 46 may be carried along a physical conductor connecting the coil 18 and the indicator 48. The indicator 48 may be a gauge, e.g., a fuel gauge in a vehicle, wherein the output signal 46 corresponding to the inductance is an electrical signal that actuates a needle according to the level 12 of fuel remaining in a fuel tank of a vehicle. Alternatively, the indicator 48 may be a display, e.g., a dashboard display in a vehicle or a value on a meter.

In operation, some elements of the sensor 10 may be disposed external to the container 40. For example, the bobbin 20 and the inductive coil 18 may be disposed external to the container 40, and the float 38 may be disposed within the container 40. Alternatively, referring to FIGS. 1 and 4, the sensor 10 may be disposed within the container 40. That is, the member 16, the bobbin 20, the inductive coil 18, and the float 38 may be disposed in, i.e., contained by, the container 40. The sensor 10 may be affixed to one or more sides of the container 40 by, for example, adhesives, bolts, screws, and/or welds. Further, to prevent contact between the fluid 14 and an uncoated inductive coil 18, the inductive coil 18 may be spray-coated. In particular, the inductive coil 18 may be spray-coated with a protective coating for applications requiring exposure of the inductive coil 18 to the fluid 14, such as for applications including the sensor 10 disposed within the container 40.

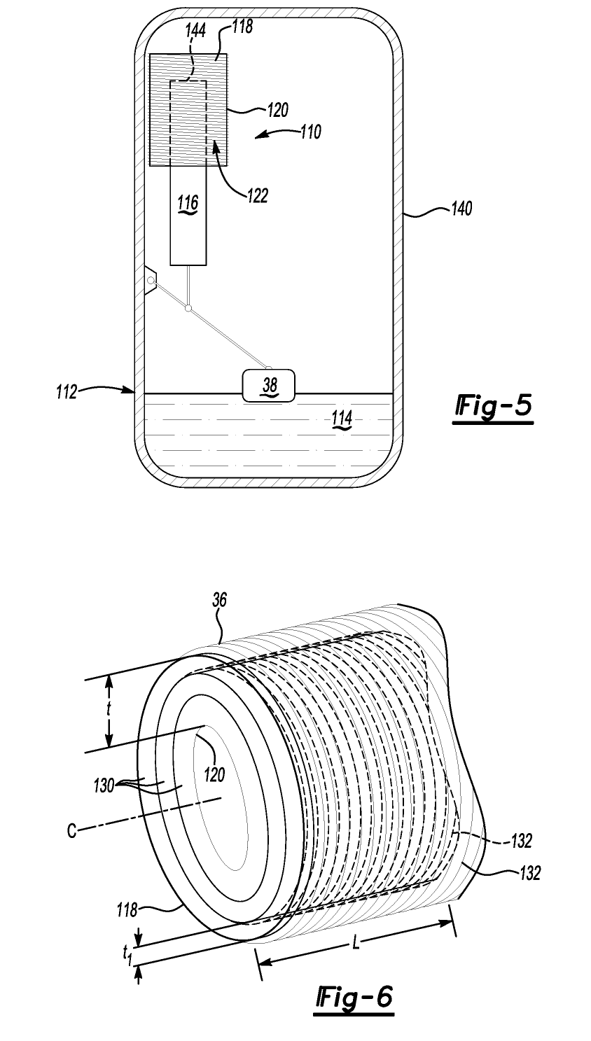

Referring to FIGS. 5 and 6, a sensor 110 for measuring a level 112 of a fluid 114 includes a member 116 and a bobbin 120. The bobbin 120 defines a cavity 122 therethrough and is configured for receiving the member 116. The sensor 110 also includes inductive coil 118 wound to the bobbin 120, wherein the inductive coil 118 defines a plurality of symmetrical layers 130 that each extend along an axial length, L, of the bobbin 120, and wherein each individual symmetrical layer 130 of the plurality of symmetrical layers 130 includes a substantially equal number of turns 132. The sensor 110 may also include inductive coil 118 wound to the bobbin 120, wherein the inductive coil 118 defines the plurality of symmetrical layers 130 that each extend along substantially the entire axial length, L, of the bobbin 120, and wherein each individual symmetrical layer 130 of the plurality of symmetrical layers 130 includes a substantially equal number of turns 132. That is, the number of turns 132, i.e., single complete revolutions about the bobbin 120, which form each individual symmetrical layer 130 is substantially equal for each individual symmetrical layer 130 wound to the bobbin 120. Further, the sensor 110 includes a float 138 operably connected to the member 116 and buoyant in the fluid 114 having a level 112 in a container 140. The member 116 axially translates within the cavity 122 in response to a change in position of the float 138 according to the level 112 of the fluid 114 so that an inductance of the inductive coil 118 varies in relation to a position 144 of the member 116 within the cavity 122 and thereby in relation to the level 112 of the fluid 114.

Referring to FIG. 6, the symmetrical layers 130 may not be staggered, e.g. may not be asymmetrical. Stated differently, when stacked radially from a central longitudinal axis C of the bobbin 120, the symmetrical layers 130 may not be staggered. Rather, the symmetrical layers 130 may be wound to the bobbin 120 so that the inductive coil 118 has a substantially equal cross-sectional thickness, t, along the axial length, L, of the bobbin 120. The symmetrical layers 130 may also be wound to the bobbin 120 so that the inductive coil 118 has the substantially equal cross-sectional thickness, t, along substantially the entire axial length, L, of the bobbin 120. That is, the number of turns 132 of each individual symmetrical layer 130 may not differ from layer 130 to layer 130 along corresponding portions and the axial length, L, of the inductive coil 118. The number of turns 132 of each individual symmetrical layer 130 also may not differ from layer 130 to layer 130 along corresponding portions and substantially the entire axial length, L, of the inductive coil 118. Stated differently, each individual symmetrical layer 130 may have a substantially equal cross-sectional thickness, ti, along the axial length, L, of the bobbin 120 so that each individual symmetrical layer 130 is substantially symmetrical with every other individual symmetrical layer 130. More specifically, each individual symmetrical layer 130 may have a substantially equal cross-sectional thickness, tₗ, along substantially the entire axial length, L, of the bobbin 120 so that each individual symmetrical layer 130 is substantially symmetrical with every other individual symmetrical layer 130. Therefore, the individual symmetrical layers 130 may be wound, e.g., stacked about, the bobbin 120, to form the inductive coil 118 having the substantially equal cross-sectional thickness, t, along the axial length, L, of the bobbin 120. That is, the individual symmetrical layers 130 may be wound, e.g., stacked about, the bobbin 120, to form the inductive coil 118 having the substantially equal cross-sectional thickness, t, along substantially the entire axial length, L, of the bobbin 120.

Since the sensors 10, 110 of the invention do not include contact between a resistive material and a wiper arm, the sensors 10, 110 are not subject to oxidative degradation. Therefore, the sensors 110, 10 exhibit excellent durability as compared to existing sensors, particularly for applications requiring sensor exposure to degraded gasoline. Further, since the sensors 10, 110 may be disposed within a fuel tank of a vehicle, the sensors may be integrated into existing vehicles without a re-design of existing fuel tanks. Also, since the sensors 10, 110 include the symmetrical layers 30, 130 and do not require staggered layers, the sensors 30, 130 are simpler and cost-effective to manufacture as compared to existing sensors.

Referring to FIGS. 1-6, a method of measuring a level 12, 112 of a fluid 14, 114 includes providing an electrical current to at least one inductive coil 18, 118 to produce an inductance. Providing may be further defined as supplying an alternating electrical current to the inductive coil 18, 118. Alternatively, providing may be further defined as supplying a pulsed direct electrical current to the inductive coil 18, 118.

The inductive coil 18, 118 is wound to a bobbin 20, 120 defining a cavity 22, 122 therethrough. Also, the inductive coil 18, 118 defines a plurality of symmetrical layers 30, 130 that each extend along an axial length, L, of the bobbin 20, 120. The plurality of symmetrical layers 30, 130 may each also extend along substantially the entire axial length, L, of the bobbin 20, 120.

Further, a float 38, 138 is operably connected to a member 16, 116 positioned to axially translate within the cavity 22, 122 according to the level 12, 112 of the fluid 14, 114. For example, the level 12, 112 of the fluid 14, 114 in a fuel tank of a vehicle may change after refueling or after consumption of fuel during operation of the vehicle. As the level 12, 112 of the fluid 14, 114 varies, the float 38, 138 changes position according to the level 12, 112 of the fluid 14, 114. That is, since the float 38, 138 is operably connected to the member 16, 116, as the position of the float 38, 138 changes in response to a change in the level 12, 112 of the fluid 14, 114, the member 16, 116 axially translates within the cavity 22, 122.

The method also includes conveying an output signal 46, 146 corresponding to an inductance created in the inductive coil 18, 118 by the member 16, 116 when the member 16, 116 axially translates in the inductive coil 18, 118 in response to a change in the level 12, 112 of the fluid 14, 114 thereby measuring the level 12, 112 of the fluid 14, 114.

While the best modes for carrying out the invention have been described in detail, those familiar with the art to which this invention relates will recognize various alternative designs and embodiments for practicing the invention within the scope of the appended claims.

1. A sensor for measuring a level of a fluid, the sensor comprising:
a member;
a bobbin defining a cavity therethrough and configured for receiving the member;
at least one inductive coil wound to the bobbin, wherein the at least one inductive coil defines a plurality of symmetrical layers that each extend along an axial length of the bobbin; and
a float operably connected to the member and buoyant in a fluid having a level in a container;
wherein the member axially translates within the cavity in response to a change in position of the float according to the level of the fluid so that an inductance of the at least one inductive coil varies in relation to a position of the member within the cavity and thereby in relation to the level of the fluid.

2. The sensor of claim 1, wherein the at least one inductive coil is a single wire wound with turns along the axial length of the bobbin to form the plurality of symmetrical layers.

3. The sensor of claim 2, wherein each individual symmetrical layer of the plurality of symmetrical layers includes a substantially equal number of turns.

4. The sensor of claim 2, wherein the symmetrical layers are not staggered.

5. The sensor of claim 2, wherein the plurality of symmetrical layers each extend along substantially an entire axial length of the bobbin.

6. The sensor of claim 1, wherein the at least one inductive coil provides an output signal corresponding to the inductance in response to an alternating electrical current.

7. The sensor of claim 1, wherein the at least one inductive coil provides an output signal corresponding to the inductance in response to a pulsed direct electrical current.

8. The sensor of claim 1, wherein the sensor is disposed within the container.

9. The sensor of claim 1, wherein the member does not axially translate entirely beyond the at least one inductive coil.

10. The sensor of claim 1, wherein the member does not contact the at least one inductive coil.

11. The sensor of claim 1, wherein the member is magnetic.

12. The sensor of claim 11, wherein the bobbin is nonmagnetic.

13. The sensor of claim 1, wherein the sensor is a fuel level sensor for a vehicle.

14. A sensor for measuring a level of a fluid, the sensor comprising:
a member;
a bobbin defining a cavity therethrough and configured for receiving the member;
at least one inductive coil wound to the bobbin, wherein the at least one inductive coil defines a plurality of symmetrical layers that each extend along an axial length of the bobbin;
wherein each individual symmetrical layer of the plurality of symmetrical layers includes a substantially equal number of turns; and
a float operably connected to the member and buoyant in a fluid having a level in a container;
wherein the member axially translates within the cavity in response to a change in position of the float according to the level of the fluid so that an inductance of the at least one inductive coil varies in relation to a position of the member within the cavity and thereby in relation to the level of the fluid.

15. The sensor of claim 14, wherein the symmetrical layers are not staggered.

16. A method of measuring a level of a fluid, the method comprising:
providing an electrical current to at least one inductive coil to produce an inductance;
wherein the at least one inductive coil is wound to a bobbin defining a cavity therethrough;
wherein the at least one inductive coil defines a plurality of symmetrical layers that each extend along an axial length of the bobbin;
wherein a float is operably connected to a metal member positioned to axially translate within the cavity according to the level of the fluid; and
conveying an output signal corresponding to an inductance created in the at least one inductive coil by the member when the member axially translates in the at least one inductive coil in response to a change in the level of the fluid thereby measuring the level of the fluid.

17. The method of claim 16, wherein providing is further defined as supplying an alternating electrical current to the at least one inductive coil.

18. The method of claim 16, wherein providing is further defined as supplying a pulsed direct electrical current to the at least one inductive coil.
